(19) United States
(12) Patent Application Publication
(10) Pub. No.: US 2024/0221705 A1
(43) Pub. Date: Jul. 4, 2024

(54) DEVICE TO CLOSE WOODWIND INSTRUMENT TONE HOLES

(71) Applicant: Nathan Owen Brown, Seattle, WA (US)

(72) Inventor: Nathan Owen Brown, Seattle, WA (US)

(73) Assignee: Key Leaves, Inc., Seattle, WA (US)

(21) Appl. No.: 18/401,680

(22) Filed: Jan. 1, 2024

Related U.S. Application Data
(60) Provisional application No. 63/478,186, filed on Jan. 2, 2023.

(51) Int. Cl. G10D 9/047; G10D 7/08

(52) U.S. Cl. CPC G10D 9/047; G10D 7/08

(57) ABSTRACT

The present disclosure describes a device for sealing woodwind musical instrument tone holes.

### TECHNICAL FIELD

The present disclosure generally relates to the field of musical instruments, and in particular, to woodwind instruments.

### BACKGROUND

When a young child or person with small hands is first learning to play the saxophone their small hands struggle to reach around the saxophone. It is common for a student with small hands to accidentally press open the left hand palm keys (D. D sharp. F) causing wrong notes and frustration. Because of this it is common for music teachers to advise a small handed student to delay learning until their grip length grows. Sadly, the saxophone palm keys that block early learning for small hands are rarely used or taught during the first year of learning.

While it is common to see ¼ scale violins made for smaller students, it is very rare to find smaller scale saxophones. Those that are available are expensive.

Small handed saxophone students need a low-cost way to remove bulky palm keys so the saxophone is more slender to grasp and easier for small handed learners.

### SUMMARY

The present disclosure describes a device for removing a woodwind key and sealing closed the related tone hole with a water tight and air tight cover. Selectively removing bulky woodwind keys and sealing closed their related tone hole openings, allows people with small hands to reach around the instrument and play.

### Terms

Various terms used in the present disclosure are described as follows, although such terms may have other descriptions included in the present disclosure.

“Musical Instrument.” “Wind Instrument,” “Woodwind” or “Instrument” refers to any portable woodwind instrument. For example, saxophone, clarinet, flute, oboe, etc.

“Body,” or “Body Tube” refers to any part of a woodwind musical instrument used for the generation of sound, or the surface along which, or through which, the sound resonates and/or travels. The body includes the structure through which the forced air and/or sound vibrations flow.

“Tone Hole” refers to any opening of a woodwind instrument that the musician opens or closes via key mechanism or finger closure to adjust musical tone.

“Tone Hole Chimney,” or “Chimney” refers to the portion of a woodwind instrument body that extends out from the tone hole up toward the key pad or valve pad or finger closure that opens and closes the tone hole.

“Cover Piece” or “Tone Hole Cover” refers to any device, ancillary to a woodwind instrument, that is intended to cause a closure seal of a tone hole or related tone hole chimney, thus disabling the venting operation of that woodwind instrument tone hole.

“Adhesive,” refers to any substance that adheres to or causes materials to stick fast to a tone hole or tone hole chimney.

“Key Mechanism,” or “keys” refers to the body ribs, posts, rods, arms, key touches, key tabs, springs, key cups, pads, bumpers, guards, feet, levers, auxiliary levers, or a lyre holder of a musical instrument.

### BRIEF DESCRIPTION OF THE ILLUSTRATIVE EMBODIMENTS

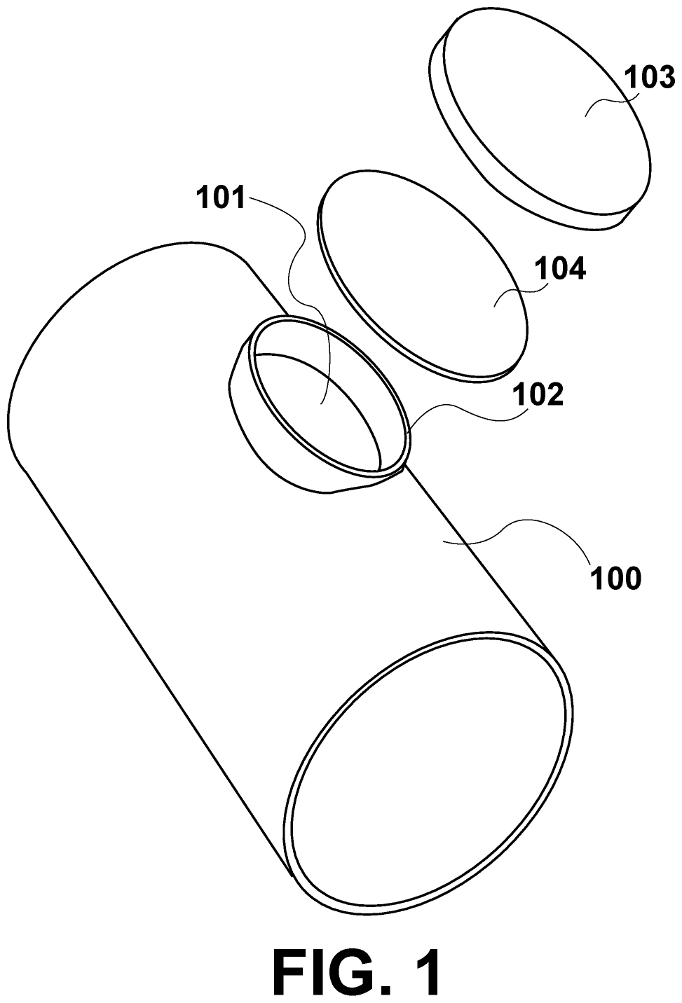

FIG. 1 shows an exploded view of an example cover piece for sealing a woodwind tone hole opening.

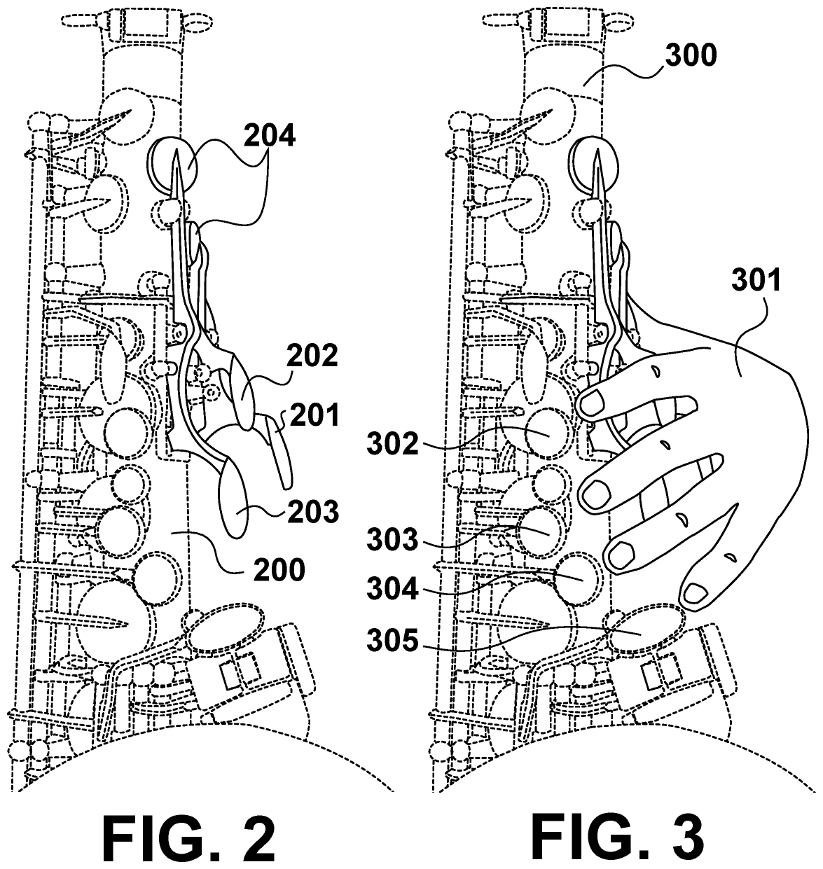

FIG. 2 shows a section view of a common alto saxophone.

FIG. 3 is the same as FIG. 2 but also includes a depiction of a small left hand struggling to reach around the palm keys (D. D sharp. F).

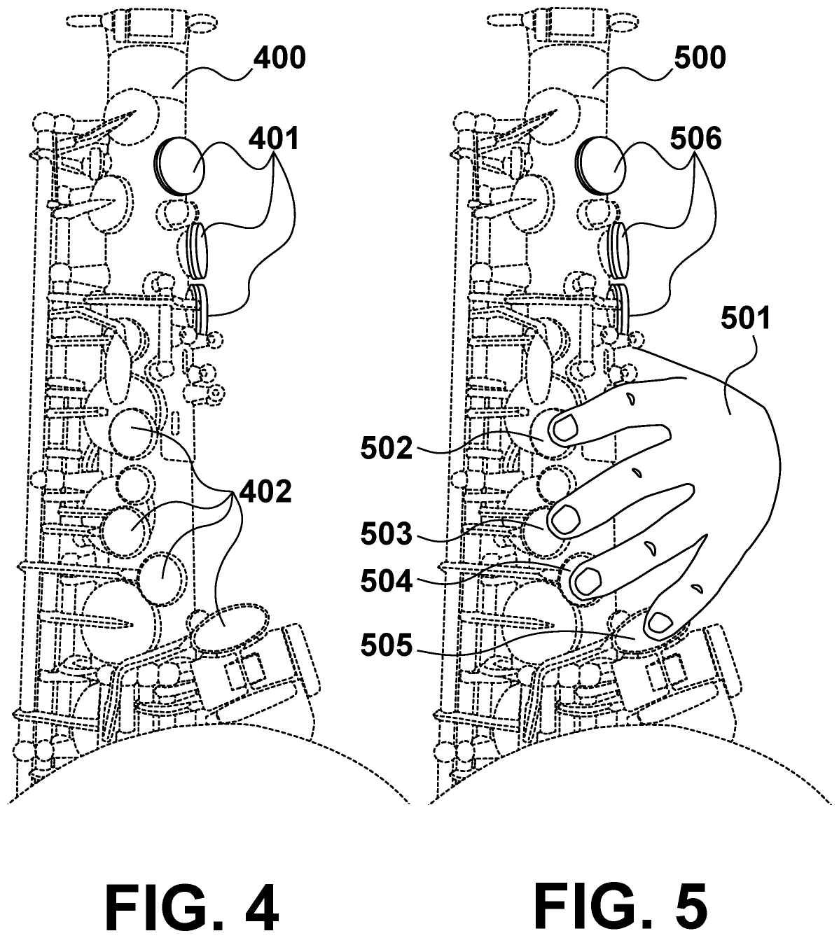

FIG. 4 shows a section view of a common alto saxophone having the three left hand palm keys (D. D sharp. F) removed, and three tone hole cover pieces added via adhesive to the saxophone to seal the tone holes related to the three removed palm keys.

FIG. 5 Is the same as FIG. 4 but includes a depiction of a small left hand reaching easily around the saxophone because the protruding palm keys have been removed and the related tone hole openings sealed via tone hole cover pieces.

### DETAILED DESCRIPTION

It should be noted that although various devices are described below with reference to sealing saxophone tone holes, devices are not intended to be limited only to saxophones. The devices may be scaled and adjusted to work with any woodwind musical instrument.

FIG. 1 Shows an exploded view of an example tone hole cover piece including 103 and 104 interacting with a saxophone body tube section 100 having a tone hole opening 101 and tone hole chimney 102. The flexible circular adhesive disc 104 would be pressed between the tone hole chimney 102 and the rigid cover piece 103 to form an airtight and watertight seal of the tone hole opening 101. The adhesive disc 104 is made of flexible adhesive membrane or a foam adhesive to allow adaptive adhesion to the tone hole chimney edge 102 even if the tone hole chimney is bent, chipped, or not level.

FIG. 2 Shows an alto saxophone body section 200 including common key mechanisms. The common left hand palm key touches 201, 202, 203 are drawn in solid lines and include the key touches of palm D key 201, palm D sharp key 202, and palm F key 203 that operate their corresponding palm key cups and pads (from this view angle, the D sharp and F key cups are visible as 204). FIG. 2 shows how the common left hand palm key touches 201, 202, 203 protrude a significant distance away from the saxophone body tube 200. This palm key protrusion is designed so an average adult-sized hand can easily use the left hand palm to press and operate the palm key touches 201, 202, 203.

FIG. 3 is the same as FIG. 2 but also includes a depiction of a small left hand 301 that is too small to reach around the saxophone 300 palm key mechanism protrusions, and normally operate the left hand finger key touches 302, 303, 304, 305.

FIG. 4 Shows one possible embodiment of a cover pieces 401 (drawn in solid lines) interacting with an alto saxophone body tube section 400 having already had the three palm keys (D. D sharp. F) removed, so that three tone hole cover pieces 401 can be adhered to the tone hole chimney openings of the removed palm keys to form an air tight and water tight closure. By removing the left hand palm keys and sealing the palm key tone holes with tone hole cover pieces, the saxophone 400 is made more slender and easy to grasp so the player can operate the standard left hand finger key touches 402.

FIG. 5 Is the same as FIG. 4 but also includes a depiction of a small left hand 501 reaching easily around the saxophone 500 to operate left hand finger key touches 502, 503, 504, 505. This is made possible because the three protruding palm keys were previously removed and the related tone holes sealed closed via tone hole cover pieces 506, making the saxophone key mechanisms more slender and easier to reach and play.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed:

1. A woodwind musical instrument tone hole cover piece including adhesive material that can adhere to a tone hole or tone hole chimney sufficient to form a closure seal of the tone hole.

2. The device of claim 1 wherein the cover piece includes a rigid outer piece.

3. The device of claim 1 wherein the cover piece includes a flexible outer piece.

4. The device of claim 1 wherein the cover piece is made entirely of flexible adhesive.
